(19) United States
(12) Patent Application Publication
(10) Pub. No.: US 2013/0131254 A1
(43) Pub. Date: May 23, 2013

(54) PROCESS FOR PRODUCING POLYMER DISPERSIONS

(71) Applicants: Detlef Bloos, Eberbach (DE); Stephan Massoth, Biblis (DE); Wolfgang Tschepat, Darmstadt (DE); Matthias Fischer, Floersheim-Dalsheim (DE)

(72) Inventors: Detlef Bloos, Eberbach (DE); Stephan Massoth, Biblis (DE); Wolfgang Tschepat, Darmstadt (DE); Matthias Fischer, Floersheim-Dalsheim (DE)

(73) Assignee: Evonik Oil Additives GmbH, Darmstadt (DE)

(21) Appl. No.: 13/813,175

(22) PCT Filed: Jul. 22, 2011
(86) PCT No.: PCT/EP11/62592

§ 371 Date: Jan. 30, 2013

(30) Foreign Application Priority Data
Sep. 23, 2010 (DE) 10 2010 041 242.2

(51) Int. Cl. B29B 7/00

(52) U.S. Cl. CPC B29B 7/002
USPC 524/505; 524/570

(57) ABSTRACT

The present invention relates to a process for producing a dispersion comprising at least one carrier medium, at least one emulsifier and at least one polymer based on polyolefins, by dispersing a heterogeneous composition using a mixer which works by the rotor-stator principle. The present invention additionally describes a polymer dispersion obtainable by the process.

The present invention relates to processes for producing polymer dispersions. The present invention additionally describes polymer dispersions obtainable by the present process.

Viscosity index improvers for motor oils are usually essentially hydrocarbon-based polymers. Typical addition rates in motor oils are, according to the thickening action of the polymers, about 0.5-6% by weight. Particularly inexpensive viscosity index improvers are olefin copolymers (OCPs) which are formed predominantly from ethylene and propylene, or hydrogenated copolymers (HSDs) of dienes and styrene.

The excellent thickening action of these polymer types is countered by laborious processibility in the production of lubricant oil formulations. Especially the poor solubility in the oils which form the basis of the formulations presents difficulties. In the case of use of solid polymers which have not been predissolved, the result is thus long stirring-in periods, for which there is a reliance on the use of specific stirrer and/or pregrinder mechanisms.

When concentrated polymers already predissolved in oil are used as commercial supply forms, only a 10-15% supply form of the OCPs or HSDs is achievable. Higher concentrations are accompanied by excessively high current viscosities of the solutions (>15 000 mm²/s at room temperature) and are therefore effectively no longer manageable. Especially with this background, highly concentrated dispersions of olefin copolymers and hydrogenated diene/styrene copolymers have been developed.

The dispersion technology described allows the production of polymer solutions with more than 20% OCP or HSD content to obtain kinematic viscosities which allow convenient incorporation into lubricant oil formulations. In principle, the synthesis of such systems includes the use of a so-called emulsifier or of a dispersing component. Standard dispersing components include OCP and HSD polymers, onto which alkyl methacrylates or alkyl methacrylate/styrene mixtures have usually been grafted. Additionally known are dispersions in which a solvent which is a relatively good solvent for the methacrylate constituent of the dispersion and a relatively poor solvent for the OCP or HSD component is used. Such a solvent together with the methacrylate component of the product forms the main constituent of the continuous phase of the dispersion. Considered in formal terms, the OCP or HSD component constitutes the main constituent of the discontinuous or disperse phase.

The prior art is considered to include the following documents:
Diplom thesis by Robert Murmann entitled “Verfahrenstechnische Auslegung der Dispergierstufe einer neu zu planenden Produktionsanlage” [Technical design of the dispersion stage of a newly planned production plant], dated Sep. 28, 1998
DE 32 07 291
DE 32 07 292
DE 102 49 292
DE 102 49 294
DE 102 49 295
U.S. Pat. No. 5,130,359

The Diplom thesis by Mr. Murmann addresses the development and the comparison of various dispersion processes for production of stable dispersions. The study examines the following apparatuses for suitability: stirrer with various stirrer units in a reactor, static mixer in pipeline, and homogenizers according to the rotor/stator principle. The standard process for producing a dispersion is the stirrer. The investigations demonstrate that stable dispersions can be produced with this applied process, with sufficient reliability for prevention of a phase inversion. The two other processes featured unsatisfactory results throughout.

DE 32 07 291 describes processes which enable increased olefin copolymer input. The olefin copolymer content is said to be 20-65% in relation to the total weight of the dispersion. The subject matter of the invention is that use of suitable solvents which have poor solubility for olefin copolymers and good solubility for PAMA-containing components affords more highly concentrated dispersions. DE 32 07 291 should be understood as a process patent which describes, more particularly, the production of dispersions. The dispersion is effected in a stirrer.

Publication DE 32 07 292 corresponds essentially to DE 32 07 291, but should if anything be understood as protection for particular copolymer compositions. These compositions are produced by an analogous process to that described in DE 32 07 291.

Documents DE 102 49 292, DE 102 49 294 and DE 102 49 295 describe, more particularly, product alterations which contribute to a distinct improvement in the product properties, more particularly in the storage stability. In this case, different carrier materials are used, and the dispersion is effected with a stirrer.

U.S. Pat. No. 5,130,359 protects systems in which exclusively functionalized olefin copolymers are employed for production of the concentrates. Such polymers with defined functionalization are, for example, copolymers from anionic polymerization processes or olefin copolymers derivatized with acids. For production of the concentrated olefin copolymer dispersions, a very complicated, time-consuming and costly production process is described. In this process, the olefin copolymer is supplied to the reactor in dissolved form, and the carrier medium or solvent then has to be removed again in a complex manner.

The processes detailed above lead to polymer dispersions with a usable profile of properties. However, there is a continuing need to make these processes more economically viable and to improve the profile of properties of the polymer dispersions.

In view of the prior art, it is thus an object of the present invention to provide a process for producing polymer dispersions with an improved profile of properties.

In particular need of improvement is the level of cost and inconvenience involved with the production of the dispersions detailed above. For instance, dispersion times of up to 10 hours at relatively high temperatures are typically described, and dilution with a carrier medium at elevated temperature is in many cases stipulated in order to achieve sufficient stability.

A further difficulty with the processes described in the prior art is the process regime, in that relatively minor errors in the control of the process can lead easily to a phase inversion. Furthermore, the process should be usable for dispersion of a multitude of different polyolefins without any need for complex parameter adjustment,

A further permanent problem is the stability of the dispersions. It should be considered here that polymer dispersions have to be stored over long periods, generally without using cooling apparatus. The storage time includes particularly transport etc., where temperatures above 40° C. or even 50° C. occur.

It was a further object of the present invention to provide polymer dispersions with a low viscosity coupled with high polyolefin content. The higher the OCP or HSD content, in general, the higher the viscosity of the dispersion. On the other hand, a high content of these polymers is desirable in order to lower the transport costs. It should be considered here that a relatively low viscosity allows relatively simple and relatively rapid mixing of the viscosity index improver into the base oil. Therefore, polymer dispersions having a particularly low viscosity were to be provided.

In addition, the processes for producing the aforementioned polymer dispersions are relatively difficult to control, and so particular specifications can be complied with only with very great difficulty. Accordingly, polymer dispersions whose viscosity can be easily adjusted to given values were to be provided.

It was a further object to specify polymer dispersions having a high content of polyolefins, especially of olefin copolymers and/or of hydrogenated block copolymers.

In addition, the polymer dispersions were to be producible in a simple and inexpensive manner, and commercially available components in particular were to be used. At the same time, production was to be possible on the industrial scale without requiring new plants or plants of complex construction therefor.

These objects, and further objects which are not stated explicitly but are immediately derivable or discernible from the connections discussed herein by way of introduction, are achieved by a process for producing polymer dispersions having all features of claim 1. Appropriate modifications of the process according to the invention are protected in the dependent claims referring back to claim 1.

The present invention accordingly provides a process for producing a dispersion comprising at least one carrier medium, at least one emulsifier and at least one polymer based on polyolefins, which is characterized in that a heterogeneous composition is dispersed using a mixer which works by the rotor-stator principle.

It is thus possible in an unforeseeable manner to provide a process for producing a dispersion having an improved profile of properties.

Thus, the level of cost and inconvenience associated with the production of the dispersions detailed above is very low, and there is in many cases no need for dilution with a carrier medium at elevated temperature in order to achieve sufficient stability.

Moreover, the processes according to the invention lead to a simpler process regime, and minor errors in the control of the process do not cause phase inversion. In addition, the process can serve for dispersion of a multitude of different polyolefins without any need for complex parameter adjustment.

In addition, the dispersions obtainable by the present process exhibit excellent stability. Accordingly, the present polymer dispersions can be stored over an exceptionally long period, even at elevated temperatures.

In addition, the polymer dispersions have a relatively low viscosity based on the polyolefin content.

In addition, the present processes for production of the polymer dispersions are relatively easy to control, and so compliance with particular specifications can be achieved in a very problem-free manner. At the same time, the viscosity of a polymer dispersion can easily be adjusted to given values.

Moreover, the present polymer dispersions may have a high content of polyolefins, especially of olefin copolymers and/or of hydrogenated block copolymers.

Furthermore, the polymer dispersions can be produced in a simple and inexpensive manner, and it is possible to use commercially available components in particular. At the same time, production is possible on the industrial scale without any need of new plants or plants of complex construction therefor.

The dispersions to be produced by the present invention comprise typically at least three components, referred to hereinafter as components A), B) and C).

### Component A)

As a component essential to the invention, the polymer dispersion comprises polyolefins which preferably have viscosity index-improving or thickening action. Such polyolefins have been known for some time and are described in the documents cited in the prior art.

These polyolefins include especially polyolefin copolymers (OCP) and hydrogenated styrene-diene copolymers (HSD).

The polyolefin copolymers (OCP) for use in accordance with the invention are known per se. These are primarily polymers formed from ethylene, propylene, isoprene, butylene and/or further α-olefins having 5 to 20 carbon atoms, as have already been recommended as VI improvers. Likewise usable are systems which have been grafted with small amounts of oxygen- or nitrogen-containing monomers (for example 0.05 to 5% by weight of maleic anhydride). The copolymers containing diene components are generally hydrogenated in order to reduce the oxidation sensitivity and the crosslinking tendency of the viscosity index improvers.

The molecular weight Mw is generally 10 000 to 300 000, preferably between 50 000 and 150 000. Such olefin copolymers are described, for example, in German published specifications DE-A 16 44 941, DE-A 17 69 834, DE-A 19 39 037, DE-A 19 63 039 and DE-A 20 59 981.

Ethylene-propylene copolymers are particularly useful, and terpolymers with the known ter components, such as ethylidenenorbornene (cf. Macromolecular Reviews, vol. 10 (1975)) are likewise possible, but the tendency thereof to crosslink in the aging process should be taken into account. The distribution may be substantially random, but it is also advantageously possible to employ sequence polymers with ethylene blocks. The ratio of the ethylene-propylene monomers is variable within certain limits, which can be set at about 75% for ethylene and about 80% for propylene as the upper limit. Due to the reduced solubility tendency thereof in oil, polypropylene is already less suitable than ethylene-propylene copolymers. As well as polymers with predominantly atactic propylene incorporation, it is also possible to use those with more marked iso- or syndiotactic propylene incorporation.

Such products are commercially available, for example, under the trade names Dutral® CO 034, Dutral® CO 038, Dutral® CO 043, Dutral® CO 058, Buna® EPG 2050 or Buna® EPG 5050.

The hydrogenated styrene-diene copolymers (HSD) are likewise known, these polymers being described, for example, in DE 21 56 122. These are generally hydrogenated isoprene- or butadiene-styrene copolymers. The ratio of diene to styrene is preferably in the range from 2:1 to 1:2, more preferably approx. 55:45. The molecular weight Mw is generally 10 000 to 300 000, preferably between 50 000 and 150 000. The proportion of double bonds after the hydrogenation is, in a particular aspect of the present invention, at most 15%, more preferably at most 5%, based on the number of double bonds prior to the hydrogenation.

Hydrogenated styrene-diene copolymers can be obtained commercially under the trade names ®SHELLVIS 50, 150, 200, 250 or 260.

The polyolefins to be used can be used here in any form. For example, the original polymerization product can be used. In addition, it is also possible to use polyolefins whose molecular weight has been subjected to mechanical and/or thermal degradation.

In general, the proportion of components A) is at least 20% by weight, preferably at least 30% by weight and more preferably at least 40% by weight, without any intention that this should impose a restriction. In a particular aspect of the present invention, the proportion of the polyolefins in the dispersion may be 20 to 70% by weight, more preferably 30 to 50% by weight.

### Component B)

Component B) is formed by at least one dispersing component which can be considered as an emulsifier. The compounds suitable as an emulsifier or dispersing component are detailed in the above-cited publications DE 32 07 291, filed Mar. 1, 1982 at the German Patent Office with application number P 3207291.0; DE 32 07 292, filed Mar. 1, 1982 at the German Patent Office with application number P 3207292.9; DE 102 49 292, filed Oct. 22, 2002 at the German Patent and Trade Mark Office with application number 102 49 292.1; DE 102 49 294, filed Oct. 22, 2002 at the German Patent and Trade Mark Office with application number 102 49 294.8; DE 102 49 295, filed Oct. 22, 2002 at the German Patent and Trade Mark Office with application number 102 49 295.6; and US 5 130 359, filed Jun. 29, 1990 at the US Patent Office (USPTO) with application Ser. No. 546,225, the disclosures of these publications, especially the emulsifiers or dispersing components described therein, being incorporated by reference into the present application for the purposes of disclosure.

Preferred dispersing components can frequently be regarded as block copolymers. Preferably, at least one of these blocks has a high compatibility with the above-described polyolefins of component A), in which case at least one further block among those present in the dispersing components has only a low compatibility with the above-described polyolefins. Such dispersing components are known per se, preferred compounds being described in the prior art cited above.

The radical compatible with component A) generally exhibits nonpolar character, whereas the incompatible radical is polar in nature. In a particular aspect of the present invention, preferred dispersing components can be regarded as block copolymers which comprise one or more A blocks and one or more X blocks, said A block comprising olefin copolymer sequences, hydrogenated polyisoprene sequences, hydrogenated copolymers of butadiene/isoprene or hydrogenated copolymers of butadiene/isoprene and styrene, and said X block comprising polyacrylate, polymethacrylate, styrene, α-methylstyrene or N-vinylheterocyclic sequences and/or sequences of mixtures of polyacrylate, polymeth-acrylate, styrene, α-methylstyrene or N-vinylheterocycles.

Preferred dispersing components can be prepared by graft polymerization, by grafting polar monomers onto the above-described polyolefins, especially onto the OCPs and HSDs. To this end, the polyolefins can be pretreated by mechanical or/and thermal degradation.

The polar monomers include especially (meth)acrylates and styrene compounds.

The expression “(meth)acrylates” includes methacrylates and acrylates, and mixtures of the two.

In a particular aspect of the present invention, in the grafting reaction, a monomer composition is used comprising one or more (meth)acrylates of the formula (I)

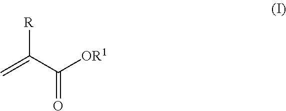

in which R is hydrogen or methyl and R¹ is hydrogen, a linear or branched alkyl radical having 1 to 40 carbon atoms.

The preferred monomers of the formula (I) include (meth)acrylates which derive from saturated alcohols, such as methyl (meth)acrylate, ethyl (meth)acrylate, n-propyl (meth)acrylate, isopropyl (meth)acrylate, n-butyl (meth)-acrylate, tert-butyl (meth)acrylate, pentyl (meth)acrylate, hexyl (meth)acrylate, 2-ethylhexyl (meth)acrylate, heptyl (meth) acrylate, 2-tert-butylheptyl (meth) acrylate, octyl (meth)acrylate, 3-isopropylheptyl (meth) acrylate, nonyl (meth)acrylate, decyl (meth)acrylate, undecyl (meth)acrylate, 5-methylundecyl (meth)acrylate, dodecyl (meth) acrylate, 2-methyldodecyl (meth) acrylate, tridecyl (meth) acrylate, 5-methyltridecyl (meth) acrylate, tetradecyl (meth) acrylate, pentadecyl (meth) acrylate, hexadecyl (meth) acrylate, 2-methylhexadecyl (meth) acrylate, heptadecyl (meth) acrylate, 5-isopropylheptadecyl (meth) acrylate, 4-tert-butyloctadecyl (meth) acrylate, 5-ethyloctadecyl (meth) acrylate, 3-isopropyloctadecyl (meth) acrylate, octadecyl (meth) acrylate, nonadecyl (meth) acrylate, eicosyl (meth) acrylate, cetyleicosyl (meth)acrylate, stearyleicosyl (meth)acrylate, docosyl (meth)acrylate and/or eicosyltetratriacontyl (meth)-acrylate; (meth)acrylates which derive from unsaturated alcohols, for example 2-propynyl (meth)acrylate, allyl (meth)acrylate, vinyl (meth)acrylate, oleyl (meth)acrylate; cycloalkyl (meth)acrylates such as cyclopentyl (meth)-acrylate, 3-vinylcyclohexyl (meth)acrylate, cyclohexyl (meth) acrylate, bornyl (meth) acrylate.

In addition, the monomer composition may comprise one or more (meth)acrylates of the formula (II)

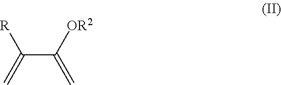

in which R is hydrogen or methyl and R² is an alkyl radical which has 2 to 20 carbon atoms and is substituted by an OH group, or an alkoxylated radical of the formula (III)

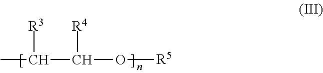

in which R³ and R⁴ are each independently hydrogen or methyl, R⁵ is hydrogen or an alkyl radical having 1 to 40 carbon atoms and n is an integer from 1 to 90.

(Meth)acrylates of the formula (III) are known to those skilled in the art. They include hydroxyalkyl (meth)acrylates such as
3-hydroxypropyl methacrylate,
3,4-dihydroxybutyl methacrylate,
2-hydroxyethyl methacrylate,
2-hydroxypropyl methacrylate, 2,5-dimethyl-1,6-hexanediol (meth) acrylate,
1,10-decanediol (meth) acrylate,
1,2-propanediol (meth)acrylate;
polyoxyethylene and polyoxypropylene derivatives of (meth)acrylic acid, such as
triethylene glycol (meth) acrylate,
tetraethylene glycol (meth)acrylate and
tetrapropylene glycol (meth)acrylate.

The (meth)acrylates with a long-chain alcohol radical can be obtained, for example, by reacting the corresponding acids and/or short-chain (meth)acrylates, especially methyl (meth)acrylate or ethyl (meth)acrylate, with long-chain fatty alcohols, which generally forms a mixture of esters, for example (meth)acrylates with various long-chain alcohol radicals. These fatty alcohols include Oxo Alcohol® 7911 and Oxo Alcohol® 7900, Oxo Alcohol® 1100 from Monsanto; Alphanol® 79 from ICI; Nafol® 1620, Alfol® 610 and Alfol® 810 from Condea; Epal® 610 and Epal® 810 from Ethyl Corporation; Linevol® 79, Linevol® 911 and Dobanol® 25L from Shell AG; Lial 125 from Augusta® Mailand; Dehydad® and Lorol® from Henkel KGaA and Linopol® 7-11 and Acropol® 91 from Ugine Kuhlmann.

In addition, the monomer composition may comprise one or more (meth)acrylates of the formula (IV)

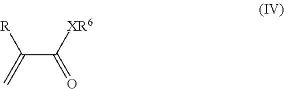

in which R is hydrogen or methyl, X is oxygen or an amino group of the formula —NH— or —NR⁷— in which R⁷ is an alkyl radical having 1 to 40 carbon atoms, and R⁶ is a linear or branched alkyl radical which has 2 to 20, preferably 2 to 6, carbon atoms and is substituted by at least one —NR⁸R⁹-group where R⁸ and R⁹ are each independently hydrogen, an alkyl radical having 1 to 20, preferably 1 to 6 carbon atoms or in which R⁸ and R⁹, including the nitrogen atom and optionally a further nitrogen or oxygen atom, form a 5-or 6-membered ring which may optionally be substituted by C₁-C₆-alkyl.

The (meth)acrylates or (meth)acrylamides of the formula (IV) include amides of (meth)acrylic acid such as
N-(3-dimethylaminopropyl)methacrylamide,
N-(diethylphosphono)methacrylamide,
1-methacryloylamido-2-methyl-2-propanol,
N-(3-dibutylaminopropyl)methacrylamide,
N-t-butyl-N-(diethylphosphono)methacrylamide,
N,N-bis(2-diethylaminoethyl)methacrylamide,
4-methacryloylamido-4-methyl-2-pentanol,
N-(methoxymethyl)methacrylamide,
N-(2-hydroxyethyl)methacrylamide,
N-acetylmethacrylamide,
N-(dimethylaminoethyl)methacrylamide,
N-methyl-N-phenylmethacrylamide,
N,N-diethylmethacrylamide,
N-methylmethacrylamide,
N,N-dimethylmethacrylamide,
N-isopropylmethacrylamide;
aminoalkyl methacrylates such as
tris(2-methacryloyloxyethyl)amine,
N-methylformamidoethyl methacrylate,
2-ureidoethyl methacrylate;
heterocyclic (meth)acrylates such as 2-(1-imidazolyl)ethyl (meth)acrylate, 2-(4-morpholinyl)ethyl (meth)acrylate and 1-(2-methacryloyloxyethyl)-2-pyrrolidone.

In addition, the monomer composition may comprise styrene compounds. These include styrene, substituted styrenes with an alkyl substituent in the side chain, for example α-methylstyrene and α-ethylstyrene, substituted styrenes with an alkyl substituent on the ring, such as vinyltoluene and p-methylstyrene, halogenated styrenes, for example monochlorostyrenes, dichlorostyrenes, tribromostyrenes and tetrabromostyrenes.

In addition, the monomer compositions may comprise heterocyclic vinyl compounds such as 2-vinylpyridine, 3-vinylpyridine, 2-methyl-5-vinylpyridine, 3-ethyl-4-vinylpyridine, 2,3-dimethyl-5-vinylpyridine, vinyl-pyrimidine, vinylpiperidine, 9-vinylcarbazole, 3-vinyl-carbazole, 4-vinylcarbazole, 1-vinylimidazole, 2-methyl-l-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles.

In addition to styrene compounds and (meth)acrylates, preferred monomers are especially monomers which have dispersing effects, for example the aforementioned heterocyclic vinyl compounds. These monomers are also referred to as dispersing monomers.

The aforementioned ethylenically unsaturated monomers can be used individually or as mixtures. It is additionally possible to vary the monomer composition during the polymerization.

The weight ratio of the parts of the dispersing component which are compatible with the polyolefins, especially of the A blocks, relative to the parts of the dispersing component which are incompatible with the polyolefins, especially the X blocks, may be within wide ranges. In general, this ratio is in the range from 50:1 to 1:50, especially 20:1 to 1:20 and more preferably 10:1 to 1:10.

The preparation of the dispersing components described above is known in the technical field. For example, the preparation can be effected by means of polymerization in solution. Such processes are described, inter alia, in DE-A 12 35 491, BE-A 592 880, U.S. Pat. No. 4,281,081, U.S. Pat. No. 4,338,418 and U.S. Pat. No. 4,290,025.

This can be done by initially charging a suitable reaction vessel, appropriately equipped with stirrer, thermometer, reflux condenser and metering line, with a mixture of the OCP and one or more of the monomers detailed above.

On completion of dissolution under an inert atmosphere, for example nitrogen, while heating, for example to 110° C., a proportion of a free-radical initiator which is customary per se, for example from the group of the peresters, is used, at first, for example, approx. 0.7% by weight based on the monomers. Accordingly, a mixture of the residual monomers with addition of further initiator, for example approx. 1.3% by weight based on the monomers, is metered in over several hours, for example 3.5 hours. Appropriately, a little further initiator is supplied a certain time after the feeding has ended, for example after 2 hours. The total polymerization time can be assumed, as a guide value, for example, to be approx. 8 hours. After the end of polymerization, the mixture is appropriately diluted with a suitable solvent, for example a phthalic ester such as dibutyl phthalate. In general, a virtually clear, viscous solution is obtained.

In addition, the polymer dispersions can be produced in a kneader, an extruder or a static mixer. The treatment in the machine under the influence of the shear forces, the temperature and the initiator concentration causes a degradation in the molecular weight of the polyolefin, especially of the OCP or HSD.

Examples of initiators suitable in the graft copolymerization are cumene hydroperoxide, dicumyl peroxide, benzoyl peroxide, azodiisobutyronitrile, 2,2-bis(t-butylperoxy)butane, diethyl peroxydicarbonate and tert-butyl peroxide. The processing temperature is between 80° C. and 350° C. The residence time in the extruder or kneader is between 1 minute and 10 hours.

The longer the dispersion is treated in the kneader or extruder, the lower the molecular weight will be. The temperature and the concentration of free radical-forming initiators can be set according to the desired molecular weight. The solvent-free polymer-in-polymer dispersion can be converted by processing in suitable carrier media to a readily manageable liquid polymer/polymer emulsion.

The proportion of components B) is generally up to 30% by weight, and this proportion is especially in the range from 5 to 15% by weight, without any intention that this should impose a restriction. The use of greater amounts of component B) is frequently uneconomic. Smaller amounts lead in many cases to a lower stability of the polymer dispersion.

### Component C)

Component C) is essential to the success of the present invention. The solvents usable as the liquid carrier medium should be inert and entirely uncontroversial. Carrier media which meet the conditions mentioned belong, for example, to the group of esters, ethers and/or to the group of higher alcohols. In general, the molecules of the compound types useful as carrier medium contain more than 8 carbon atoms per molecule.

It should be mentioned that mixtures of the above-described solvents are also useful for the carrier medium.

The compounds suitable as the carrier medium are detailed in the above-cited publications DE 32 07 291, filed Mar. 1, 1982 at the German Patent Office with application number P 3207291.0; DE 32 07 292, filed Mar. 1, 1982 at the German Patent Office with application number P 3207292.9; DE 102 49 292, filed Oct. 22, 2002 at the German Patent and Trade Mark Office with application number 102 49 292.1; DE 102 49 294, filed Oct. 22, 2002 at the German Patent and Trade Mark Office with application number 102 49 294.8; DE 102 49 295, filed Oct. 22, 2002 at the German Patent and Trade Mark Office with application number 102 49 295.6, the disclosures of these publications, especially the carrier media described therein, being incorporated into the present application by reference for the purposes of disclosure.

In the group of the esters, emphasis should be given to: phosphoric esters, esters of dicarboxylic acids, esters of monocarboxylic acids with diols or polyalkylene glycols, esters of neopentyl polyols with monocarboxylic acids (cf. Ullmanns Encyclopädie der Technischen Chemie, 3^{rd} ed., vol. 15, p. 287-292, Urban & Schwarzenber (1964)). Useful esters of dicarboxylic acids include firstly the esters of phthalic acid, especially the phthalic esters with C₄ to C₈ alcohols, particular mention being made of dibutyl phthalate and dioctyl phthalate, and then the esters of aliphatic dicarboxylic acids, especially the esters of straight-chain dicarboxylic acids with branched-chain primary alcohols. Particular emphasis is given to the esters of sebacic acid, adipic acid and azelaic acid, and particular mention should be made of the 2-ethylhexyl and isooctyl-3,5,5-trimethyl esters, and the esters with the C₈, C₉ and C₁₀ oxo alcohols.

Of particular significance are the esters of short-chain primary alcohols with branched dicarboxylic acids. Examples include alkyl-substituted adipic acid, for example 2,2,4-trimethyladipic acid.

Useful alcohol components are advantageously, for example, the aforementioned oxo alcohols. Esters of monocarboxylic acids with diols or polyalkylene glycols which should be emphasized are the diesters with diethylene glycol, triethylene glycol, tetraethylene glycol up to decamethylene glycol, and also with dipropylene glycol as alcohol components. Monocarboxylic acids which should be mentioned specifically include propionic acid, (iso)butyric acid and pelargonic acid—mention being made by way of example of dipropylene glycol dipelargonate and diethylene glycol dipropionate and diisobutyrate and the corresponding esters of triethylene glycol, and also tetraethylene glycol di-2-ethylhexanoate.

Preferred carrier media are nonionic surfactants. These include fatty acid polyglycol esters, fatty amine polyglycol ethers, alkyl polyglycosides, fatty amine N-oxides and long-chain alkyl sulfoxides.

In addition, the group of nonionic surfactants includes the aforementioned esters with ethoxy groups.

A further group of particularly preferred carrier media which are nonionic surfactants is that of alcohols etherified with (oligo)oxyalkyl groups.

These include especially ethoxylated alcohols having more preferably 1 to 20 and especially 2 to 8 ethoxy groups. The hydrophobic radical of the ethoxylated alcohols comprises preferably 1 to 40 and preferably 4 to 22 carbon atoms, it being possible to use either linear or branched alcohol radicals. Likewise usable are oxo alcohol ethoxylates.

Examples of commercially available ethoxylates which can be used for production of the inventive concentrates are ethers of the Lutensol® A brands, especially Lutensol® A 3 N, Lutensol® A 4 N, Lutensol® A 7 N and Lutensol® A 8 N, ethers of the Lutensol® TO brands, especially Lutensol® TO 2, Lutensol® TO 3, Lutensol® TO 5, Lutensol® TO 6, Lutensol® TO 65, Lutensol® TO 69, Lutensol® TO 7, Lutensol® TO 79, Lutensol® 8 and Lutensol® 89, ethers of the Lutensol® AO brands, especially Lutensol® AO 3, Lutensol® AO 4, Lutensol® AO 5, Lutensol® AO 6, Lutensol® AO 7, Lutensol® AO 79, Lutensol® AO 8 and Lutensol® AO 89, ethers of the Lutensol® ON brands, especially Lutensol® ON 30, Lutensol® ON 50, Lutensol® ON 60, Lutensol® ON 65, Lutensol® ON 66, Lutensol® ON 70, Lutensol® ON 79 and Lutensol® ON 80, ethers of the Lutensol® XL brands, especially Lutensol® XL 300, Lutensol® XL 400, Lutenso® XL 500, Lutensol® XL 600, Lutensol® XL 700, Lutensol® XL 800, Lutensol® XL 900 and Lutensol® XL 1000, ethers of Lutensol® AP brands, especially Lutensol® AP 6, Lutensol® AP 7, Lutensol® AP 8, Lutensol® AP 9, Lutensol® AP 10, Lutensol® AP 14 and Lutensol® AP 20, ethers of the IMBENTIN® brands, especially of the IMBENTIN®-AG brands, of the IMBENTIN®-U brands, of the IMBENTIN®-C brands, of the IMBENTIN®-T brands, of the IMBENTIN®-OA brands, of the IMBENTIN®-POA brands, of the IMBENTIN®-N brands and of the IMBENTIN®-O brands, and ethers of the Marlipal® brands, especially Marlipal® 1/7, Marlipal® 1012/6, Marlipal® 1618/1, Marlipal® 24/20, Marlipal® 24/30, Marlipal® 24/40, Marlipal® O13/20, Marlipal® O13/30, Marlipal® O13/40, Marlipal® O25/30, Marlipal® O25/70, Marlipal® O45/30, Marlipal® O45/40, Marlipal® O45/50, Marlipal® O45/70 and Marlipal® O45/80.

Particular preference is given especially to mixtures which comprise alcohols etherified with (oligo)oxyalkyl groups and esters. Such mixtures exhibit unexpectedly high stability. This is especially true of dispersions which comprise hydrogenated styrene-diene copolymers (HSD). In this case, the weight ratio of ester to alcohol etherified with (oligo)oxyalkyl groups may be within wide ranges. This ratio is more preferably in the range from 15:1 to 1:15, especially 5:1 to 1:5.

A further group of preferred carrier media is that of mineral oils, which are preferably used in combination of the media detailed above. It has been found that, surprisingly, the stability of the polymer dispersion can be enhanced considerably by the presence of mineral oil.

Mineral oils are known per se and commercially available. They are generally obtained from petroleum or crude oil by distillation and/or refining and optionally further purification and finishing processes, the term mineral oil including the higher-boiling fractions in particular of crude oil or petroleum. In general, the boiling point of mineral oil is higher than 200° C., preferably higher than 300° C., at 5000 Pa. Production by low-temperature carbonization of shale oil, coking of hard coal, distillation of brown coal with exclusion of air, and hydrogenation of hard or brown coal is likewise possible. A small proportion of mineral oils is also produced from raw materials of vegetable origin (for example from rapeseed, jojoba) or animal origin (for example neatsfoot oil). Accordingly, mineral oils have, according to their origin, different proportions of aromatic, cyclic, branched and linear hydrocarbons.

In general, a distinction is drawn between paraffin-base, naphthenic and aromatic fractions in crude oils or mineral oils, the term “paraffin-base fraction” representing longer-chain or highly branched isoalkanes, and “naphthenic fraction” representing cycloalkanes. In addition, mineral oils have, according to their origin and finishing, different proportions of n-alkanes, isoalkanes having a low degree of branching, known as mono-methyl-branched paraffins, and compounds having heteroatoms, in particular O, N and/or S, to which a degree of polar properties are attributed. However, the assignment is difficult, since individual alkane molecules may have both long-chain branched groups and cycloalkane radicals, and aromatic parts. For the purposes of the present invention, the assignment can be effected to DIN 51 378, for example. Polar fractions can also be determined to ASTM D 2007.

The proportion of n-alkanes in preferred mineral oils is less than 3% by weight, the proportion of O—, N— and/or S-containing compounds less than 6% by weight. The proportion of the aromatics and of the mono-methyl-branched paraffins is generally in each case in the range of 0 to 40% by weight. In one interesting aspect, mineral oil comprises mainly naphthenic and paraffin-base alkanes which have generally more than 13, preferably more than 18 and most preferably more than 20 carbon atoms. The fraction of these compounds is generally ≧60% by weight, preferably ≧80% by weight, without any intention that this should impose a restriction. A preferred mineral oil contains 0.5 to 30% by weight of aromatic fractions, 15 to 40% by weight of naphthenic fractions, 35 to 80% by weight of paraffin-base fractions, up to 3% by weight of n-alkanes and 0.05 to 5% by weight of polar compounds, based in each case on the total weight of the mineral oil.

An analysis of particularly preferred mineral oils, which was effected by means of conventional processes such as urea separation and liquid chromatography on silica gel, shows, for example, the following constituents, the percentages relating to the total weight of the particular mineral oil used:
n-alkanes having approx. 18 to 31 carbon atoms:
0.7-1.0%,
slightly branched alkanes having 18 to 31 carbon atoms:
1.0-8.0%,
aromatics having 14 to 32 carbon atoms:
0.4-10.7%,
iso- and cycloalkanes having 20 to 32 carbon atoms:
60.7-82.4%,
polar compounds:
0.1-0.8%,
loss:
6.9-19.4%.

Valuable information with regard to the analysis of mineral oils and a list of mineral oils which have a different composition can be found, for example, in Ullmann's Encyclopedia of Industrial Chemistry, 5th Edition on CD-ROM, 1997, under “lubricants and related products”.

In a particular aspect of the present invention, the carrier medium used comprises mixtures comprising mineral oil and nonionic surfactants, especially alcohols etherified with (oligo)oxyalkyl groups.

Such mixtures exhibit unexpectedly high stability. In this case, the weight ratio of mineral oil to nonionic surfactant, especially to alcohol etherified with (oligo)oxyalkyl groups, may be within wide ranges. This ratio is more preferably in the range from 15:1 to 1:15 and especially 5:1 to 1:5.

Among the carrier media detailed above, preference is given especially to nonionic surfactants, particular preference being given to the said esters with ethoxy groups and (oligo)oxyalkyl groups etherified alcohols.

The proportion of the carrier medium in the concentrated polymer dispersion may be within wide ranges, this proportion being dependent especially on the polyolefins and dispersing components used. In general, the proportion of the carrier medium is 79 to 25% by weight, preferably below 70, especially 60 to 40% by weight, based on the overall polymer dispersion.

As well as the components mentioned, the inventive dispersions may comprise further components and additives. These include, more particularly, the compounds which are detailed in DE 102 49 292, filed Oct. 22, 2002 at the German Patent and Trade Mark Office with application number 102 49 292.1, and have a dielectric constant greater than or equal to 9, especially greater than or equal to 20 and more preferably greater than or equal to 30; these compounds are incorporated into the present application by reference to publication DE 102 49 292 for the purposes of disclosure.

The dielectric constant can be determined according to Handbook of Chemistry and Physics, David R. Lide, 79th Edition, CRS Press specified methods, the dielectric constant being measured at 20° C.

The present process serves more particularly for production of a dispersion, with dispersion of the components detailed above, which at first form a heterogeneous composition with relatively large particles. Accordingly, the polyolefins, which are typically in the form of relatively large particles, are comminuted in the carrier medium.

The polyolefin can preferably be introduced into a vessel in solid form, and the polymer to be dispersed can also be added in bale form, pellets or other agglomerates. To adjust the with regard to the above-defined, equipment-dependent particle size (according to equipment size and type), the polyolefin can be brought to the particle size with a comminution apparatus, for example a division system. This unit can be used together with a rotor-stator mixer.

The particle size of the polyolefins to be dispersed in the heterogeneous composition is not critical per se. Surprising advantages can be achieved by virtue of the particle size of the polyolefins prior to the treatment with a mixer which works by the rotor-stator principle being preferably in the range from 2 mm to 3 cm and more preferably in the range from 3 mm to 2 cm (edge length).

The temperature at which the polyolefin is introduced into the mixing vessel is not critical per se, and so the polyolefin can optionally also be added in liquid form. The addition temperature is preferably in the range from 10 to 120° C., more preferably in the range from 20 to 60° C.

The dispersion can be effected here in one or more steps, and so it is possible to use different rotor-stator mixing heads in order to adjust the particle size stepwise to a given value.

The polyolefin can be introduced into the mixing vessel in one step or in portions. In a particular aspect of the present invention, it is possible to initially charge large portions of the components to be dispersed, i.e. of the polyolefin, in a mixing vessel. Particular advantages can be achieved especially by a process in which 80-100% by weight and especially 95-100% by weight of polyolefin is initially charged, based on the total amount of the polyolefin.

The dispersing component can be introduced into the mixing vessel in one step or in portions. In a particular aspect of the present invention, it is possible to initially charge large portions of the dispersing component, i.e. of the emulsifier, in a mixing vessel. Particular advantages can be achieved especially by a process in which 80-100% by weight and especially 95-100% by weight of dispersing component is initially charged, based on the total amount of the dispersing component.

The carrier medium can be introduced into the mixing vessel in one step or in portions. In a particular aspect of the present invention, it is possible to initially charge large portions of the carrier medium in a mixing vessel. Particular advantages can be achieved especially by a process in which 80-100% by weight and especially 95-100% by weight of carrier medium is initially charged, based on the total amount of the carrier medium.

For dispersion of the heterogeneous composition, in the present process, a mixer which works by the rotor-stator principle is used. Such mixers generally feature the ability to produce relatively high shear forces. Accordingly, these mixers are also referred to as mixing systems with high shearing action (high-shear mixers). In this case, the particles can preferably be cut by the comminution devices, and the size can be reduced by contact with the edges of the stator.

With particular preference, it is possible to use a mixing apparatus which has a cylindrical mixing unit, the mixing unit comprising at least one mixing screen arranged longitudinally of the axis of the rotor. In addition, the mixing unit has preferably at least one and more preferably at least two feed and outlet elements arranged at right angles to the axis of the rotor, an open chamber being formed from the feed element(s) and the mixing screen. The feed elements are configured such that the heterogeneous composition to be comminuted is drawn into the mixing chamber on rotation of the rotor and is conducted outward through the mixing screen, such that the size of the particles is reduced.

Particularly suitable mixers which work by the rotor-stator principle are detailed, for example, in EP0036325A2, filed Mar. 17, 1981 at the European Patent Office with application number EP81301111.1; WO 02/060569 A2, filed Oct. 29, 2001 at the International Office as the PCT Filing Office with application number PCT/IB01/02863; and DE 22 61 808 A1, filed Dec. 14, 1972 at the German Patent Office with application number P2261808.2; the mixing apparatus described therein is incorporated into the present application by reference for the purposes of disclosure. In addition, these mixing systems can be purchased commercially from SILVERSON MACHINES LTD, Waterside, Chesham, Bucks, England.

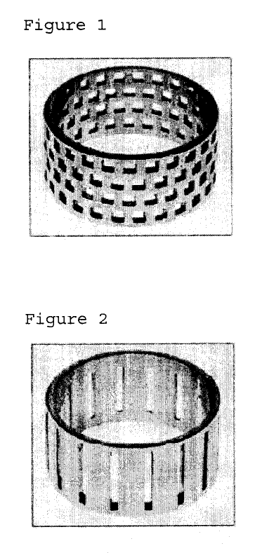

The shape of the stator is not critical per se, but preference is given to a stator with a grid structure, more particularly a quadrilateral hole structure. Another suitable stator has been found to be one with slot-like orifices. Preferred embodiments of both stator structures are shown in FIGS. 1 and 2.

The slot/the quadrilateral hole in the stator in the mixer may preferably have a width in the range from 1 to 8 mm, more preferably in the range from 2 to 5 mm.

In a particular embodiment, it is possible especially to use mixers having different stators. It is possible here for the stators to have different gaps, such that the particles are comminuted over various stages in one step. This surprisingly allows particles to be obtained with a particularly narrow particle size distribution.

In a further configuration, the mixers may have a unit for coarse comminution (cutting unit) which can cut up large parts, and according to the embodiment also bales.

The rotor of the mixer can preferably be operated at a speed in the range from 1000 to 7000, more preferably in the range from 2000 to 3000.

The peripheral velocity may preferably be in the range from 4 to 25 m/s, especially 8 to 18 m/s and more preferably 10 to 15 m/s.

In a particular aspect of the present invention, the dispersion can be effected of a temperature in the range from 60° to 200° C., more preferably in the range from 100° to 160° C.

On commencement of the dispersion, the heterogeneous composition may comprise preferably up to 30% by weight and more preferably 5 to 15% by weight of emulator.

The weight ratio of emulator to carrier medium on commencement of dispersion may preferably be in the range from 0.05 to 1.5 and more preferably in the range from 0.06 to 0.5.

In a particularly preferred embodiment, the weight ratio of polyolefin to carrier medium on commencement of dispersion may be in the range from 0.25 to 1.6 and more preferably in the range from 0.6 to 1.

In addition, the weight ratio of polyolefin to emulator on commencement of dispersion may be in the range from 0.6 to 8, more preferably in the range from 2.6 to 8.

Preferably, the kinematic viscosity of the mixture of emulsifier and carrier medium used may preferably be less than 400 mm²/s, especially less than 350 mm²/s, more preferably less than 300 mm²/s and most preferably less than 250 mm²/s, measured to DIN 51562 (Ubbelohde viscometer) at 100° C. Preferably, the kinematic viscosity of the mixture of emulsifier and carrier medium used may be in the range from 100 to 300 mm²/s and more preferably 130 to 250 mm²/s, measured to DIN 51562 (Ubbelohde viscometer) at 100° C.

Overall, a particularly preferred process may have the following component steps:

The dispersing component can be initially charged, in which case the temperature can be selected within a range from 10° C. to 120° C. Subsequently, the first dispersing tool for comminution of the component to be dispersed and for mixing of the overall reactor contents is switched on, and the component to be dispersed is added in the respective supply form (bales, pellets, agglomerates or other size distribution down to dusts).

In the second step, the introduced component to be dispersed is comminuted or mixed with the dispersing component until a homogeneous dispersion with preferably small particles has formed. During this step, due to the high shear forces which are introduced into the reactor by the comminution apparatus, the reactor contents are heated to the necessary dispersion temperature. In addition, this can be accelerated by trace heating.

According to the component to be dispersed and desired degree of dispersion, in a 3^{rd} step, the final dispersion can be produced by using a separate mixing apparatus formed from a rotor/stator system. The combination of different or else multistage rotor/stator systems allows adjustment of the quality or the storage stability of the dispersion via the particle size of the component to be dispersed. The dissipation energy introduced during this step allows the target dispersion temperature usually to be established without additional heat supply. In some cases, it may even be necessary to keep the product temperature within a desired temperature range by suitable cooling. This temperature range results from the component to be dispersed and is more preferably within a range from 90° to 200° C.

The dispersions obtainable by the present process are notable for a surprisingly good profile of properties, which differs from the known dispersions. The dispersions obtainable in accordance with the invention are accordingly novel and likewise form part of the subject matter of the present invention.

For example, preferred dispersions may have a stability according to the process described in the examples of at least 200 and preferably at least 300 points.

It has been found that, surprisingly, the quality and storage stability of the dispersions can be improved by a particularly narrow particle size distribution and a particular mean particle size. Accordingly, the particles of preferred dispersions may have a mean particle diameter in the range from 1 to 15 μm, more preferably in the range from 1 to 5 μm, measured by optical evaluation.

The narrow particle size distribution can be described especially by the proportion of particles outside a particular range. Accordingly, particularly preferred dispersions feature 90% of the particles having a diameter of less than or equal to 7 μm, more preferably less than or equal to 5 μm. In addition, 50% of the particles may have a diameter less than or equal to 5 μm, more preferably less than or equal to 2 μm. In addition, 90% of the particles may have a diameter greater than or equal to 0.5 μm, more preferably greater than or equal to 1 μm.

Preferred dispersions feature a solids content in the range from 20 to 70% by weight, more preferably in the range from 30 to 50% by weight.

The present invention is to be illustrated hereinafter with reference to examples and comparative examples, without any intention that this should impose a restriction.

### EXAMPLES AND COMPARATIVE EXAMPLES

### Methods Used

Hereinafter, TE100 is the kinematic viscosity of a liquid measured at 100° C. in a 150N oil (TE=“thickening efficiency”). The determination of the viscosity is undertaken to DIN 51562 (Ubbelohde viscometer). The concentration of the OCP in oil here is in each case 1.0% by weight. The BV40 and BV100 figures denote the kinematic viscosities of the dispersions, likewise measured to DIN 51562 (Ubbelohde viscometer), at 40° and 100° C. (BV=“bulk viscosity”). The kinematic viscosity is always stated in mm²/s.

To test the stability of a dispersion, 25 g of the product are weighed into a centrifuge bottle and centrifuged at a peripheral speed of 3000 to 4000 rpm for 20 minutes. Subsequently, the centrifuge bottle is turned through 90° and the product is assessed with regard to its flow propensity by points, 100 points characterizing the immediate flow of the product and 0 points characterizing product flow only after >10 seconds. For further distinction of the products with regard to the stability thereof, the test can be extended by two further cycles, in which case the points for the three individual cycles have to be added up to give a total number of points. The test was stopped early if only 0 points were achieved in one cycle.

### Example 1

### OCP Dispersion with Keltan in Silverson High Shear Laboratory System

A 2 l beaker equipped with a Silverson laboratory mixer

[Duplex unit with comminuting apparatus and additional dispersing unit (dispersing head used: General Purpose Disintegrating Head)] was initially charged with 864.1 g of a mixture of carrier medium and emulsifier, and 435.9 g of an ethylene-propylene-diene copolymer (e.g. Keltan® 4802 with a TE100 of ˜18.9 mm²/s) were weighed in at a speed of ˜5500 rpm. The ethylene-propylene-diene copolymer was subsequently comminuted with the comminuting apparatus at 110° C. to 140° C. for 20 minutes. Subsequently, the Duplex unit was exchanged for a standard Silverson dispersing unit (dispersing head used: square-hole high-shear screen)], and the mixture present was dispersed at 140° C. to 180° C. for 3 hours.

The BV100 of the product thus produced is 3086 mm²/s. The TE100 of a 2.8% solution of the product (1% OCP in solution) in a 150 N oil is 18.99 mm²/s.

The resulting dispersion was subjected to the above-described stability test, and the test was extended to 120 minutes. In this test, a total number of 250 points was attained.

### Comparative Example 1

### OCP Dispersion with Keltan in a Witt's Flask

In a 1 liter Witt's flask equipped with a multilevel Inter-MIG stirrer (ratio of stirrer to vessel diameter=0.7) and a speed of 150 rpm, 316.7 g of a mixture of carrier medium and emulsifier and 183.3 g of an ethylene-propylene-diene copolymer (e.g. Keltan® 4802 with a TE100 of ˜18.9 mm²/s) were weighed in. The mixture was subsequently heated to 100° C. At 150 rpm, a pale brownish dispersion formed within 9-10 hours, which tends to separation of the ethylene-propylene-diene copolymer within a few weeks at room temperature. For stabilization, the temperature was therefore increased from 100° C. to 140° C. and stirring was continued at 150 rpm for 6 hours. Subsequently, dilution was effected with 45.4 g of an ethoxylated fatty alcohol (e.g. Marlipal® O13/20) to polymer content 55%, and the mixture was stirred at 100° C. for a further half hour. In this process, the total production time was 19 hours.

The BV100 of the product thus produced is 1336 mm²/s. The TE100 of a 2.8% solution of the product (1% OCP in solution) in a 150 N oil is 16.57 mm²/s.

The resulting dispersion was subjected to the above-described stability test, and the test was extended to 120 minutes. In this test, a total number of 100 points was attained.

The test data detailed above show, surprisingly, that the production time could be reduced to an unexpected degree. Thus, the production time was reduced by 75% from 16 hours to 4 hours. In addition, an extremely surprising rise in the stability of the novel, inventive dispersion was found.

1. A process for producing a dispersion, the process comprising:
dispersing a heterogeneous composition with a rotor-stator mixer,
wherein the dispersion comprises a carrier medium, an emulsifier, and a polyolefin-based polymer.

2. The process of claim 1, wherein the heterogeneous composition comprises up to 30% by weight of the emulsifier prior to the dispersing.

3. The process of claim 1, wherein the emulsifier is a block copolymer.

4. The process of claim 1, further comprising:
charging a vessel with a polyolefin obtained by a process comprising comminuting with a cutting device prior to the dispersing.

5. The process of claim 1, wherein the dispersing is at a temperature of from 60° to 200° C.

6. The process of claim 1, wherein a stator of the mixer has a grid structure, a slot-like orifice, or a combination thereof.

7. The process of claim 1, wherein a stator of the mixer has a slot or a quadrilateral hole having a width of from 1 to 8 mm.

8. The process of claim 1, wherein a kinematic viscosity of a mixture of the carrier medium and the emulsifier is of from 100 to 300 mm²/s at 100° C.

9. The process of claim 1, further comprises:
initially charging at least 80% by weight of the polymer prior to the dispersing.

10. A dispersion obtained by a process comprising the process of of claim 1.

11. The dispersion of claim 10, wherein a proportion of the polyolefin-based polymer is from 20 to 70% by weight.

12. The dispersion of claim 10, wherein particles of the dispersion have a mean particle diameter of from 1 to 15 μm.

13. The dispersion of claim 10, wherein 90% of particles in the dispersion have a diameter less than or equal to 7 μm.

14. The dispersion of claim 10, wherein 90% of the particles have a diameter greater than or equal to 0.5 μm.

15. The dispersion of claim 10, wherein stability of the dispersion is at least 200.

16. The dispersion of claim 10, wherein a weight ratio of the polyolefin-based polymer to the emulsifier is of from 0.6 to 8.

17. The process of claim 1, wherein the heterogeneous composition comprises from 5 to 15% by weight of the emulsifier prior to the dispersion.

18. The process of claim 1, wherein a stator of the mixer has the slot or the quadrilateral hole having a width of from 2 to 5 mm.

19. The dispersion of claim 10, wherein a proportion of the polyolefin-based polymer is from 30 to 50% by weight.

20. The dispersion of claim 10, wherein particles of the dispersion have a mean particle diameter of from 1 to 5 μm.
